(19) United States
(12) Patent Application Publication
(10) Pub. No.: US 2025/0169599 A1
(43) Pub. Date: May 29, 2025

(54) INTERACTIVE CONTROL METHOD

(71) Applicant: GUANGZHOU STARS PULSE CO.,LTD., GUANGZHOU (CN)

(72) Inventor: ZHIGAO LUO, GUANGZHOU (CN)

(21) Appl. No.: 18/954,946

(22) Filed: Nov. 21, 2024

(30) Foreign Application Priority Data
Nov. 24, 2023 (CN) 202311585361.2

(51) Int. Cl. A46B 15/00; A46B 13/02; A61C 17/22; H04W 4/80

(52) U.S. Cl. CPC A46B 15/0004; A46B 13/023; A61C 17/221; H04W 4/80

(57) ABSTRACT

An interactive control method includes: obtaining, by a terminal, connection information in a case that an oral care device and the terminal are connected to each other via BLUETOOTH; and displaying, by the terminal, current operating parameters of the oral care device based on the connection information. The connection information includes operating parameters of the oral care device when terminal is connected to the terminal via the BLUETOOTH.

### TECHNICAL FIELD

The present disclosure relates to a field of oral cares, and in particular to an interactive control method.

### BACKGROUND

In the related art, an electric toothbrush is connected to a portable smart device, such as a smart phone, via BLUETOOTH, so a user is enabled to set and view relevant parameters of the electric toothbrush and to view relevant real-time reminders and messages of the electric toothbrush on the portable smart device to control the electric toothbrush.

When BLUETOOTH connection between the electric toothbrush and the smart device is disconnected, the relevant parameters of the electric toothbrush viewed by the user through the portable smart device may not be synchronized with actual parameters of the electric toothbrush, such that the user may control the electric toothbrush at a low efficiency, and a control experience is poor.

### SUMMARY OF THE DISCLOSURE

The present disclosure provides an interactive control method though which connection information is obtained when BLUETOOTH connection is established, and current operating parameters of an oral care device are displayed according to the connection information. In this way, the user can be intuitively informed of current and actual operating parameters of the oral care device.

In a first aspect, an interactive control method includes: obtaining, by a terminal, connection information in a case that an oral care device and the terminal are connected to each other via BLUETOOTH; where the connection information includes a plurality of operating parameters of the oral care device when the oral care device is connected to the terminal via the BLUETOOTH; and displaying, by the terminal, a current operating parameter of the oral care device based on the connection information.

In a second aspect, an interactive control method includes: sending, by an oral care device in a case that the oral care device and a terminal are connected to each other via BLUETOOTH, a plurality of current operating parameters of the oral care device to the terminal to enable the terminal to display the plurality of current operating parameters.

For the interactive control method provided in the present disclosure, the connection information is obtained when the BLUETOOTH connection is established, a plurality of current operating parameters of the oral care device are displayed based on the connection information. The plurality of current operating parameters are displayed based on the connection information rather than a plurality of operating parameters set when the BLUETOOTH connection is disconnected. In this way, operating parameters corresponding to a current operating state of the oral care device are displayed, and therefore, the user is accurately informed of the current operating state of the oral care device, the user can control the oral care device more efficiently, and a usage experience is improved.

Additional aspects and characteristics of the embodiments of the present disclosure are partly provided in the following description, and partial of the additional aspects and the characteristics will become apparent based on the following description or be learnt based on practice of the embodiments of the present disclosure.

### BRIEF DESCRIPTION OF THE DRAWINGS

The above and/or additional aspects and characteristics of the present disclosure will become apparent and readily understood based on description of the embodiments in combination with the following accompanying drawings.

FIG. 1 is a schematic diagram of an application of an interactive control method according to embodiments of the present disclosure.

FIG. 2 is a flow chart of the interactive control method according to embodiments of the present disclosure.

FIG. 3 is a flow chart of the interactive control method according to embodiments of the present disclosure.

FIG. 4 is a scenario of performing the interactive control method according to embodiments of the present disclosure.

FIG. 5 is a flow chart of the interactive control method according to embodiments of the present disclosure.

FIG. 6 is a flow chart of the interactive control method according to embodiments of the present disclosure.

FIG. 7 is a scenario of performing the interactive control method according to embodiments of the present disclosure.

FIG. 8 is a scenario of performing the interactive control method according to embodiments of the present disclosure.

FIG. 9 is a flow chart of the interactive control method according to embodiments of the present disclosure.

FIG. 10 is a flow chart of the interactive control method according to embodiments of the present disclosure.

FIG. 11 is a flow chart of the interactive control method according to embodiments of the present disclosure.

FIG. 12 is a flow chart of the interactive control method according to embodiments of the present disclosure.

FIG. 13 is a flow chart of the interactive control method according to embodiments of the present disclosure.

FIG. 14 is a schematic diagram of performing the interactive control method according to embodiments of the present disclosure.

FIG. 15 is a flow chart of the interactive control method according to embodiments of the present disclosure.

FIG. 16 is a module diagram of an interaction control apparatus according to embodiments of the present disclosure.

FIG. 17 is a module diagram of the interaction control apparatus according to embodiments of the present disclosure.

FIG. 18 is a schematic diagram of a connection state of a non-volatile computer-readable storage medium and a processor according to embodiments of the present disclosure.

FIG. 19 is a schematic diagram of an oral care device and a terminal being electrically connected to each other in an application scenario of the interactive control method according to embodiments of the present disclosure.

### DETAILED DESCRIPTION

Examples of following embodiments are illustrated in the accompanying drawings. A same reference numeral or similar reference numerals in the entire specification denote a same element or similar elements or elements having a same function or similar functions.

To facilitate understanding of the present disclosure, terms used in the present disclosure are explained in the following.

An oral care device is a device for providing care to an oral cavity of a user. The oral care device of the present disclosure may be an electric toothbrush, a teeth cleaner, an oral irrigator, an interdental cleaning device, a floss cleaning device, and so on. For brevity, the present disclosure is illustrated by taking the electric toothbrush as an example. A principle of the electric toothbrush is similar to that of other oral care devices, which are not be repeated herein.

In the related art, the electric toothbrush and a terminal, such as a smart phone, are generally connected via BLUETOOTH. When a series of operations of controlling the electric toothbrush via the terminal, such as setting a tooth brushing program, setting or synchronizing relevant parameters for brushing teeth, and so on, needs to be performed, a BLUETOOTH device of the terminal and a BLUETOOTH device of the electric toothbrush must be connected to each other successfully. BLUETOOTH connection between the electric toothbrush and the terminal allows the user to set up and view the relevant parameters of the electric toothbrush on the terminal and view relevant real-time reminders and messages of the electric toothbrush on the terminal to control the electric toothbrush.

When the BLUETOOTH connection between the electric toothbrush and the terminal are disconnected, and when the user sets relevant adjustment parameters of the electric toothbrush on the terminal for brushing teeth, the terminal generally displays the adjustment parameters set by the user accordingly. However, when the BLUETOOTH connection is disconnected, the terminal is unable to adjust the relevant parameters of the electric toothbrush according to the adjustment parameters set by the user.

In this case, when the BLUETOOTH connection between the electric toothbrush and the terminal is established again and the user uses the toothbrush to brush the teeth, the terminal displays the adjustment parameters set by the user when the BLUETOOTH connection is disconnected. However, the electric toothbrush is actually not operated according to the adjustment parameters displayed on the terminal. That is, the adjustment parameters that are displayed on the terminal and observed by the user are inconsistent with adjustment parameters at which the electric toothbrush is currently operating. Therefore, a tooth brushing effect and a tooth brushing experience are affected.

To solve the above technical problem, embodiments of the present disclosure provide an interactive control method.

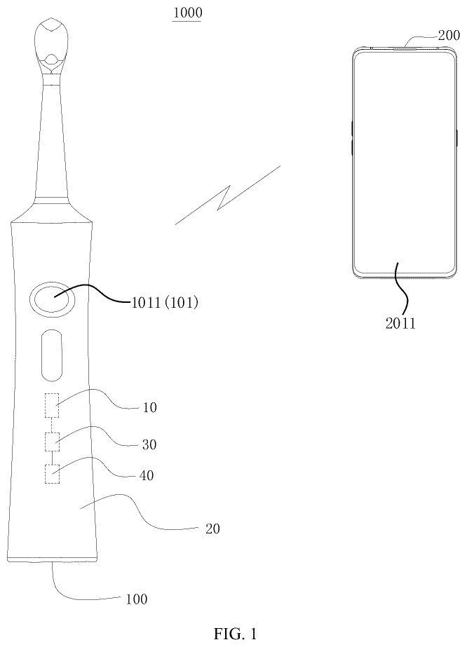

An application scenario of a technical solution of the present disclosure is firstly described below. The interactive control method provided by the present disclosure can be applied in an application scenario as shown in FIG. 1. The interactive control method is applied in an interaction control system 1000 that includes an oral care device 100.

The oral care device 100 is any device for providing oral care to the user. The present disclosure is illustrated by taking the electric toothbrush 100 as an example

The oral care device 100 of the present disclosure may include only the electric toothbrush 100, or may include the electric toothbrush 100 and a terminal 200. The electric toothbrush 100 and the terminal 200 may be connected to each other via BLUETOOTH to determine a current state (such as adjustment parameters for brushing teeth, a tooth brushing mode, and so on) of the electric toothbrush 100.

The electric toothbrush 100 includes a detection member 10, a body portion 20, a processor 30, and a memory 40. The detection member 10, the processor 30, and the memory 40 are arranged inside the body portion 20 of the electric toothbrush 100. The processor 30 is electrically connected to the detection member 10 and the memory 40.

The detection member 10 may be configured to detect a current operating state, a duration of a current displacement, a distance of the current displacement, a duration of the current operating state of the electric toothbrush 100 to obtain relevant current state information. For example, the detection member 10 is configured to detect a duration of the electric toothbrush 100 being in a first flight state or in a first standby state. Exemplarily, the detection member 10 includes, but is not limited to, one or more of: a six-axis sensor, an acceleration sensor, a three-axis sensor, a capacitance circuit, a touch-sensing circuit, a current detection circuit, and so on.

The processor 30 may be a microprocessor unit (MCU), also known as a monolithic microcomputer or a monolithic machine. The MCU is a chip-level computer, and in order to form the chip-level computer, a frequency and specifications of a central process unit (CPU) are reduced appropriately, and a memory, a counter, a USB, an A/D converter, a UART, a PLC, a DMA and other peripheral interfaces, and even an LCD drive circuit are integrated onto one chip. The MCU performs various combinations of control for various application scenarios.

In some embodiments, the processor 30 may receive the current state information of the oral care device 100 detected by the detection member 10 and control the electric toothbrush 100 to change the current state. For example, the electric toothbrush 100 is in the first flight state, and when the detection member 10 detects that the duration of the electric toothbrush 100 in the first flight state exceeds a first predetermined duration, the processor 30 controls the electric toothbrush 100 to enter a second flight state. In another example, the electric toothbrush 100 is in the first standby state, and when the detection member 10 detects that the duration of the electric toothbrush 100 in the first standby state exceeds a second predetermined duration, the processor 30 controls the electric toothbrush 100 to enter a second standby state.

In some embodiments, the processor 30 may control the electric toothbrush 100 to set a plurality of current operating parameters based on a received parameter instruction.

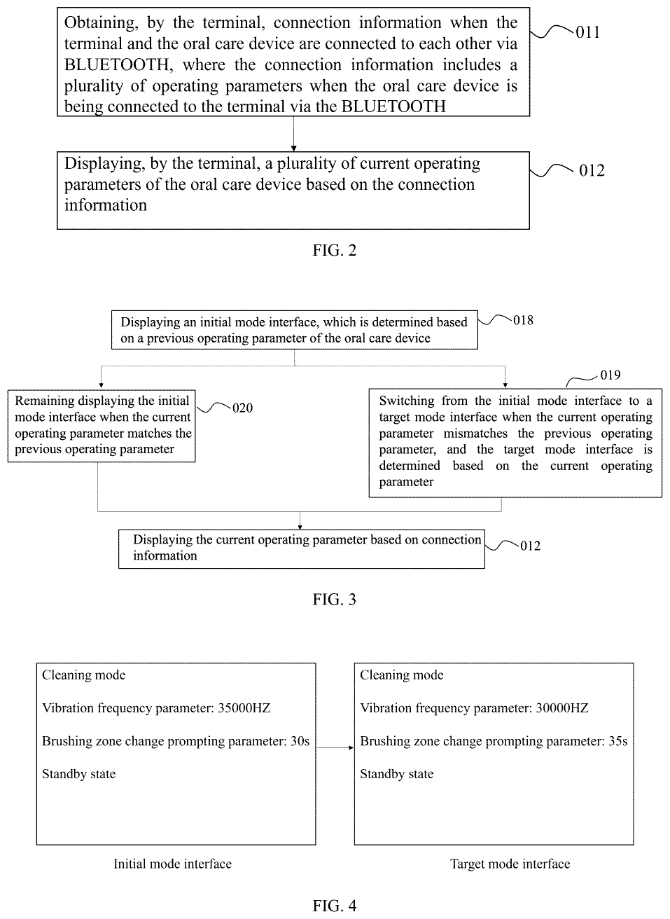

In an embodiment, the oral care device 100 further includes one or more prompting members 101. The one or more prompting members prompting members 101 are configured to prompt operating parameters of the electric toothbrush 100 to the user (such as a state mode, brushing zone change prompting parameters, and so on). The one or more prompting members 101 may be at least one of: a plurality of indicator lights, a loudspeaker, a display 1011, and so on. For example, at least one of the plurality of indicator lights corresponding to a wake-up state is controlled to be flashed or the display 1011 is controlled to be lit up to prompt the user that the electric toothbrush 100 enters the wake-up state. Exemplarily, as shown in FIGS. 1 and 2, when the one or more prompting members 101 work, the at least one of the plurality of indicator lights 1012 arranged on the electric toothbrush 100 flashes or being always lit up; the display 1011 of the electric toothbrush 100 being lit up; the electric toothbrush 100 generates a prompting sound, and so on.

In some embodiments, the one or more prompting members 101 of the electric toothbrush 100 may include the display 1011. The display 1011 may display a plurality of current mode parameters (such as a cleaning mode, a caring mode, and so on) of the electric toothbrush 100, adjustable parameters corresponding to each mode (such as a vibration amplitude, a tooth brushing duration, and so on), state parameters (such as a being-operating state, the wake-up state), and the brushing zone change prompting parameters, and so on. The display 1011 may be an interactive touch display 1011, and the user may input control instructions by touching the display 1011, such as controlling, through the interactive touch display 1011, the electric toothbrush 100 to switch between operating states.

In an embodiment, the interaction control system 1000 further includes the terminal 200. The terminal 200 includes a display 2011. The terminal 200 can communicate with the electric toothbrush 100. In this way, the terminal 200 receives data transmitted by the electric toothbrush 100 (such as connection information) and takes a processing capability to process the data, so as to control the electric toothbrush 100 (such as controlling the electric toothbrush 100 to change the plurality of operating parameters) and to display relevant contents of the electric toothbrush 100 (such as the plurality of operating parameters, the being-operating state, and so on).

In an embodiment, the terminal 200 is installed with an application (APP) that is developed to be adaptive with the electric toothbrush 100. When the terminal 200 and the electric toothbrush 100 are connected to each other via BLUETOOTH, the terminal 200 may control the electric toothbrush 100 via the APP.

In an embodiment, the terminal 200 may be, but is not limited to, any personal computer, a laptop computer, a smart phone, a tablet computer, a portable wearable device, and so on.

In an embodiment, the electric toothbrush 100 and the terminal 200 communicate with each other via a network. For example, the electric toothbrush 100 and the terminal 200 may communicate with each other wirelessly (such as communicating via Wireless Fidelity (Wi-Fi), communicating via BLUETOOTH, communicating via infrared, and so on). It is understood that communication between the electric toothbrush 100 and the terminal 200 is not limited to the above communication manners, which is not limited herein.

For example, when communicating via the BLUETOOTH or the infrared, each of the electric toothbrush 100 and the terminal 200 is arranged with a respective communication module to directly achieve the communication therebetween. Exemplarily, the electric toothbrush 100 includes a first BLUETOOTH unit 103, the terminal 200 includes a second BLUETOOTH unit 203. The first BLUETOOTH unit 103 and the second BLUETOOTH unit 203 are communicatively connected to each other. The BLUETOOTH connection between the electric toothbrush 100 and the terminal 200 may be interpreted as connection between the first BLUETOOTH unit 103 of the electric toothbrush 100 and the second BLUETOOTH unit 203 of the terminal 200.

In an embodiment, the interactive control method may be achieved by at least one of the electric toothbrush 100 and the terminal 200, such as achieved by the electric toothbrush 100 or achieved by the electric toothbrush 100 and the terminal 200 cooperating with each other.

The interactive control method of the present disclosure will be described in detail below.

As shown in FIGS. 1 and 2, the present disclosure provides an interactive control method, and the interactive control method includes following steps.

In a step 011, when the terminal 200 and the oral care device 100 are connected to each other via BLUETOOTH, the terminal 200 obtains connection information, and the connection information includes a plurality of operating parameters when the oral care device 100 is being connected via the BLUETOOTH.

The plurality of operating parameters include at least one of: mode parameters, adjustable parameters corresponding to each mode, state parameters, and brushing zone change prompting parameters. For example, the plurality of operating parameters include the mode parameters and the adjustable parameters corresponding to each mode; or, the plurality of operating parameters include the mode parameters, the adjustable parameters corresponding to each mode, the state parameters, and the brushing zone change prompting parameters.

The mode parameters may be a predetermined operating mode (or an operating gear) of the electric toothbrush 100, such as a cleaning mode (a cleaning gear), a whitening mode (a whitening gear), a caring mode (a caring gear), and so on. The adjustable parameters corresponding to each mode may include, in each mode of the electric toothbrush 100, a vibration amplitude, a vibration frequency, a brushing amplitude, a brushing frequency, and a brushing duration. The state parameters may be predetermined operating state information of the electric toothbrush 100, such as a wake-up state, a flight state, an operating state, and so on. The brushing zone change prompting parameters may be a time parameter that, after one zone of the mouth is being cleaned for a predetermined duration, prompts the user to change form the one zone to another to-be-cleaned zone, such as 20 seconds(s), 25 s, 30 s, 35 s, and so on.

The connection information includes a plurality of operating parameters of the electric toothbrush 100 being performing a tooth-brushing task when the electric toothbrush 100 is being connected via the BLUETOOTH, i.e., the plurality of current operating parameters. For example, when the terminal 200 and the electric toothbrush 100 are connected to each other via the BLUETOOTH, the current operating parameters of the electric toothbrush 100 are obtained and include the electric toothbrush being in an operating state; the working mode of the electric toothbrush 100 is the caring mode; the adjustable parameters of the caring mode include the vibration frequency of 30,000 hertz (HZ); the brushing duration of three minutes (min); and a brushing zone change prompting parameter of 30 s.

In a step 012, the terminal 200 displays the plurality of current operating parameters of the oral care device 100 based on the connection information.

Specifically, the display 2011 of the terminal 200 displays the current operating parameter of the electric toothbrush 100 based on the obtained connection information, in order to show the user the plurality of current operating parameters of the electric toothbrush 100 when performing the tooth-brushing task.

As shown in FIG. 3, in some implementations, before the step 012 in which the terminal 200 displays the plurality of current operating parameters of the oral care device 100, the interactive control method further includes following steps.

In a step 018, the display 2011 of the terminal 200 displays an initial mode interface, the initial mode interface is determined based on a plurality of previous operating parameters of the oral care device 100, and the plurality of previous operating parameters are a plurality of operating parameters when the terminal 200 and the oral care device 100 are connected to each other via BLUETOOTH at a previous time.

In a step 019, the terminal 200 switches the initial mode interface to a target mode interface when any one of the plurality of current operating parameters mismatches a respective one of the plurality of previous operating parameters, and the target mode interface is determined based on the plurality of current operating parameters.

In a step 020, the terminal 200 continues to display the initial mode interface when any one of the plurality of current operating parameters matches the respective one of the plurality of previous operating parameters.

The any one of the plurality of current operating parameters matching the respective one of the plurality of previous operating parameters means that all of the plurality of current operating parameter are respectively the same as the plurality of previous operating parameters, including: the mode parameters of the plurality of current operating parameters being the same as mode parameters of the plurality of previous operating parameters; the adjustable parameters corresponding to each mode of the plurality of current operating parameters being the same as adjustable parameters corresponding to each mode of the plurality of previous operating parameters; the state parameters of the plurality of current operating parameter being the same as state parameters of the plurality of previous operating parameters; the brushing zone change prompting parameters of the plurality of current operating parameters being the same as brushing zone change prompting parameters of the plurality of previous operating parameters. The any one of the plurality of current operating parameters mismatching the respective one of the plurality of previous operating parameters means that any one of the plurality of current operating parameters is different from the respective one of the plurality of previous operating parameters, including at least one of: the mode parameters of the plurality of current operating parameters being different from the mode parameters of the plurality of previous operating parameter; the adjustable parameters corresponding to each mode of the plurality of current operating parameters being different from the adjustable parameters corresponding to each mode of the plurality of previous operating parameters; the state parameters of the plurality of current operating parameters being different from the state parameters of the plurality of previous operating parameter; the brushing zone change prompting parameters of the plurality of current operating parameters being different from the brushing zone change prompting parameters of the plurality of previous operating parameters. For example, the mode parameters of the plurality of current operating parameters are different from the mode parameters of the plurality of previous operating parameters; or the mode parameters of the plurality of current operating parameters are the same as the mode parameters of the plurality of previous operating parameters, whereas the adjustable parameters corresponding to the mode of the plurality of current operating parameters are different from the adjustable parameters corresponding to the mode of the plurality of previous operating parameters; or the mode parameters of the plurality of current operating parameters are different from the mode parameters of the plurality of previous operating parameters, and the adjustable parameters corresponding to each mode of the plurality of current operating parameters are different from the adjustable parameters corresponding to each mode of the plurality of previous operating parameters, and the state parameters of the plurality of current operating parameters are different from the state parameters of the plurality of previous operating parameters, and the brushing zone change prompting parameters of the plurality of current operating parameters are different from the brushing zone change prompting parameters of the plurality of previous operating parameters.

Specifically, regardless of whether the terminal 200 and the oral care device 100 being connected to each other via the BLUETOOTH or not, when the APP of the terminal 200 is activated, the display 2011 of the terminal 200 displays the initial mode interface. The initial mode interface displays the plurality of operating parameters, obtained by the terminal 200, of the electric toothbrush 100 in a state when the terminal 200 and the oral care device 100 are connected to each other via the BLUETOOTH in the previous time. When it is determined that any one of the plurality of current operating parameters of the electric toothbrush 100 does not match the respective one of the plurality of previous operating parameters, i.e., any one of the plurality of current operating parameters of the electric toothbrush 100 is different from the respective one of the plurality of previous operating parameters, the initial mode interface displayed on the display 2011 of the terminal 200 is switched to the target mode interface in which the current operating parameter is displayed. When the plurality of current operating parameters of the electric toothbrush 100 match the plurality of previous operating parameters, i.e., the plurality of current operating parameters of the electric toothbrush 100 are the same as the plurality of previous operating parameters, the terminal 200 displays the initial mode interface (the plurality of current operating parameters are the same as the plurality of previous operating parameters).

For example, as shown in FIG. 4, the terminal 200 displays the initial mode interface, and operating parameters displayed in the initial mode interface re: the cleaning mode, a vibration frequency parameter in the cleaning mode being 35000 HZ, being in a standby state, and a brushing zone change prompting parameter being prompting the user to change zones in every 30 s. In the case that the electric toothbrush 100 is in the cleaning mode, having a vibration frequency parameter in the cleaning mode of 30000 HZ, being in the standby mode, and a brushing zone change prompting parameter being prompting the user to change zones in every 35 s, it is determined that the adjustable parameters (the vibration frequency) corresponding to the cleaning mode are different from the brushing zone change prompting parameters, and it is determined the plurality of current operating parameters of the electric toothbrush 100 do not match the plurality of previous operating parameters. Therefore, the terminal 200 switches the initial mode interface displayed on the display 2011 to the target mode interface, and the plurality of operating parameters displayed on the target mode interface are: the cleaning mode, the vibration frequency parameter in the cleaning mode being 30000 HZ, being in the standby state, and the brushing zone change prompting parameter being prompting the user to change zones in every 35 s.

In this way, the terminal 200 obtains the connection information when being connected to the oral care device 100 via the BLUETOOTH and displays the current operating parameter of the oral care device 100 based on the connection information. The terminal 200 displays the plurality of current operating parameters based on the connection information rather than the plurality of operating parameters set when the BLUETOOTH connection is disconnected. In this way, it is the plurality of operating parameters corresponding to the current operating state of the oral care device 100 that are displayed. Therefore, the user is accurately informed of the current operating state of the oral care device 100, the user can control the oral care device 100 more efficiently, and the user experience is improved.

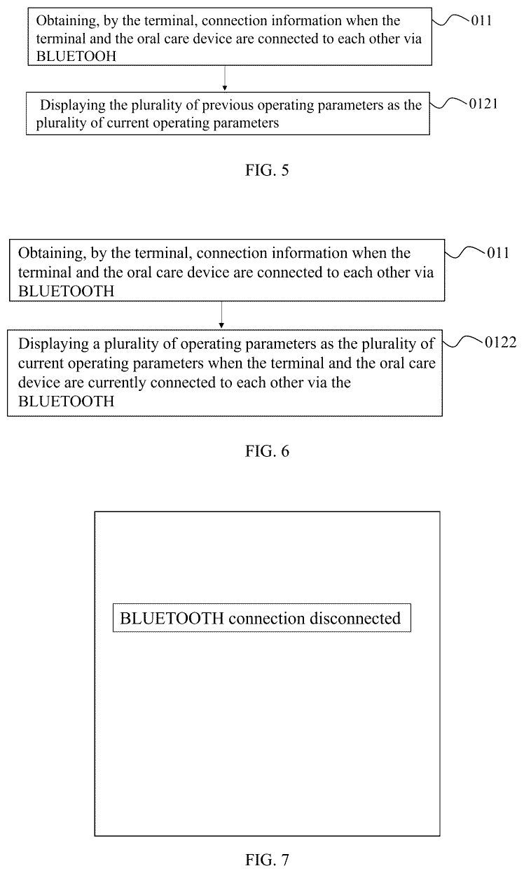

As shown in FIG. 5, in some embodiments, the connection information includes historical connection information. The historical connection information includes the plurality of previous operating parameters of the oral care device 100 when the terminal 200 and the oral care device 100 are connected to each other via BLUETOOTH at the previous time. The step 012, in which the terminal 200 displays the plurality of current operating parameters of the oral care device 100 based on the connection information, includes following steps.

In a step 0121, the terminal 200 displays the plurality of previous operating parameters as the plurality of current operating parameters.

Specifically, when the BLUETOOTH connection is maintained, the terminal 200 obtains the plurality of current operating parameters of the electric toothbrush 100 and stores the plurality of current operating parameters in the memory to obtain historical memorized operating parameters. The connection information may be the plurality of previous operating parameters of the electric toothbrush 100, i.e., the historical memorized operating parameters of the electric toothbrush 100. When the BLUETOOTH connection is disconnected, the terminal 200 is unable to modify the plurality of operating parameters of the electric toothbrush 100, and the electric toothbrush 100 maintains the plurality of previous operating parameters. When the BLUETOOTH connection is re-established, the obtained operating parameters are consistent with the historical memorized operating parameters when the terminal 200 and the oral care device 100 are connected to each other via BLUETOOTH at the previous time. In this case, the terminal 200 displays the obtained connection information, i.e., displays the plurality of previous operating parameters of the electric toothbrush 100 when the terminal 200 and the oral care device 100 are connected to each other via BLUETOOTH at the previous time.

As shown in FIG. 6, in some embodiments, the connection information includes current connection information, and the current connection information includes the plurality of current operating parameters of the oral care device 100 when the terminal 200 and the oral care device 100 are currently connected to each other via the BLUETOOTH. The step 012, in which the terminal 200 displays the plurality of current operating parameters of the oral care device based on the connection information, includes following steps.

In a step 0122, the terminal 200 displays a plurality of operating parameters when the terminal 200 and the oral care device 100 are currently connected to each other via the BLUETOOTH as the plurality of current operating parameters.

Specifically, when the terminal 200 and the oral care device 100 are being connected to each other, the terminal 200 may communicate with the electric toothbrush 100 to obtain the data transmitted by the electric toothbrush 100. For example, when the terminal 200 and the oral care device 100 are being connected to each other, the terminal 200 obtains the plurality of current operating parameters transmitted by the electric toothbrush 100 and controls the display 1011 to correspondingly display the plurality of current operating parameters of the electric toothbrush 100 to enable the user to be accurately informed of the current operating state of the electric toothbrush 100.

In some embodiments, when the BLUETOOTH connection between the terminal 200 and the oral care device 100 is disconnected, a first prompting message is sent, and at least a portion of the plurality of current operating parameters that are displayed on the terminal are set in an unadjustable state. The first prompting message is configured to prompt that the BLUETOOTH connection is disconnected.

The first prompt message is a message for prompting the user that the BLUETOOTH connection between the terminal 200 and the electric toothbrush 100 is disconnected. The first prompt message may be achieved by at least one of: voice, texts or images. For example, the terminal 200 prompts the user by displaying a text message of “BLUETOOTH connection disconnected”; or the terminal 200 prompts the user by announcing a voice message of “BLUETOOTH connection disconnected” and displaying the text message of “BLUETOOTH connection disconnected”; or the terminal 200 prompts the user by announcing the voice message of “BLUETOOTH connection disconnected”, displaying the text message of “BLUETOOTH connection disconnected”, and displaying an image indicating “BLUETOOTH connection disconnected”, and so on.

Specifically, when the BLUETOOTH connection between the terminal 200 and the electric toothbrush 100 is disconnected, the user is prompted by the first prompting message, and at least a portion of the plurality of current operating parameters displayed on the terminal are set in the unadjustable state. For example, as shown in FIG. 7, when the BLUETOOTH connection between the terminal 200 and the electric toothbrush 100 is disconnected, the text message of “BLUETOOTH connection disconnected” is sent to prompt the user that the BLUETOOTH connection between the terminal 200 and the electric toothbrush 100 has been disconnected, and at this moment, any parameter of the plurality of current operating parameters, other than the adjustable parameters corresponding to each mode (such as the vibration amplitude, the vibration frequency, the brushing amplitude, the brushing frequency, and the brushing duration), is set in the unadjustable state. For example, as shown in FIG. 8, in the flight mode in which the BLUETOOTH connection between the terminal 200 and the electric toothbrush 100 is disconnected, the first prompt message in the image indicating the “BLUETOOTH connection disconnected” is sent to prompt the user that the BLUETOOTH connection between the terminal 200 and the electric toothbrush 100 has been disconnected, and any parameter of the plurality of current operating parameters, other than a parameter representing “exiting the flight mode”, is set in the unadjustable state.

In some embodiments, the operating state of the oral care device 100 includes the flight state, the standby state, the wake-up state, and a being-operating state. The flight state includes the first flight state and the second flight state. The standby state includes a first standby state and a second standby state. When the oral care device 100 is in the first flight state, the first standby state, the wake-up state, or the being-operating state, the terminal 200 and the oral care device 100 are connected to each other via the BLUETOOTH. When the oral care device 100 is in the second flight state or the second standby state, the BLUETOOTH connection between the oral care device 100 and the terminal 200 is disconnected.

The interactive control method further includes following steps.

(1) The one or more prompting members 101 is controlled to operate in the wake-up state or the being-operating state.

(2) The one or more prompting members 101 is controlled to stop operating in the flight state or the standby state.

In the wake-up state or the being-operating state, the processor 30 controls the one or more prompting members 101 to operate to display the plurality of current operating parameters to the user. The user determines, based on a motor of the electric toothbrush 100 being operating or not operating when the one or more prompting members 101 is illuminating, that the electric toothbrush 100 is currently in the wake-up state or the being-operating state. In the flight state or the standby state, the processor 30 controls the one or more prompting members 101 to stop operating. In the flight state or the standby state, it generally indicates that the user does not need to use the electric toothbrush 100, and the one or more prompting members 101 is turned off to reduce energy consumption of the electric toothbrush 100.

The being-operating state is a state in which the motor of the electric toothbrush 100 is running. The standby state is a state that the electric toothbrush 100 enters after the motor stops running. In order to save energy, the one or more prompting members 101 of the electric toothbrush 100 does not operate in the standby state. The wake-up state is a state in which the one or more prompting members 101 operates after the motor stops running in order to remind the user what parameter settings are made in the electric toothbrush or the operating state of the electric toothbrush is having what parameters. The flight state is a state in which the electric toothbrush 100 is deactivated after the motor stops running.

It can be known, the flight state, the standby state, the wake-up state, and the being-operating state of the electric toothbrush 100 can be switched between each other in various ways. For example, the flight state, the standby state, the wake-up state, and the operating state of the electric toothbrush 100 can be switched by performing at least one of: setting the operating state in the processor 30 of the electric toothbrush 100; the terminal 200 controlling setting of the operating state in the electric toothbrush 100; or after the detection member 10 performs detection, determining that the electric toothbrush 100 meets a predetermined condition for switching between the operating states, and controlling the electric toothbrush 100 to switch between operating states.

For example, in the wake-up state, the user controls, via the terminal 200, the electric toothbrush 100 to switch to the flight state.

In another example, in the standby state, the electric toothbrush 100 is controlled to switch from the standby state to the wake-up state when the detection member 10 detects that the electric toothbrush 100 satisfies at least one of: the detection member 10 being in a handheld state; a caring member of the electric toothbrush 100 being in a connected state; a movement amplitude of the electric toothbrush 100 being greater than a predetermined amplitude; a pressure applied to the caring member of the electric toothbrush 100 being greater than a predetermined pressure; the electric toothbrush 100 satisfying a wake-up state predetermined condition for entering the wake-up state in the processor 30 of the electric toothbrush 100. Exemplarily, the caring member is, such as, a brush head of the electric toothbrush 100.

The interactive control method further includes:

(1) When an instruction of entering the flight state is received, the terminal 200 controls the oral care device 100 to enter the first flight state and controls the oral care device 100 to enter the second flight state after the first flight state lasts for a first predetermined duration.

Specifically, the terminal 200 controls the oral care device 100 to enter the first flight state when the terminal 200 receives the instruction of entering the flight state, such as any one of: the instruction of entering the flight state sent by touch control, texts or voice inputs via the display 2011 of the terminal 200; the instruction of entering the flight state that is received and sent by the electric toothbrush 100; or the instruction of entering the flight state sent by the detection member 10 of the electric toothbrush 100 when the detection member 10 detects that the electric toothbrush 100 satisfies the predetermined condition for switching to the flight state. When the oral care device 100 is in the first flight state, the BLUETOOTH device of the electric toothbrush 100 is not switched off, and the one or more prompting members 101 are switched off. That is, at this moment, the terminal 200 and the electric toothbrush 100 are connected to each other via the BLUETOOTH, and the terminal 200 still synchronize the plurality of current operating parameters with the electric toothbrush 200.

After the oral care device 100 stays in the first flight state for the first predetermined duration, such as for the first predetermined duration of 30 s, 1 min, 2 min, 3 min, 5 min, and so on, the terminal 200 controls the electric toothbrush 100 to enter the second flight state. When the oral care device 100 is in the second flight state, the BLUETOOTH device of the electric toothbrush 100 is turned off, and the one or more prompting members 101 are turned off. That is, at this moment, the terminal 200 cannot be connected to the electric toothbrush 100 via the BLUETOOTH, and that is, the BLUETOOTH connection between the terminal 200 and the oral care device 100 is disconnected.

In some embodiments, the terminal 200 controlling the oral care device 100 to enter the second flight state after the oral care device 100 staying in the first flight state for the first predetermined duration, includes that the terminal 200 controls the oral care device 100 to enter the second flight state when the oral care device 100, in the first flight state, does not receive at least one of: an instruction of exiting the flight state and other control instructions, within the first predetermined duration.

The other control instructions may be, in the first flight state: a control instruction of controlling the electric toothbrush 100 to enter any operating state other than the flight state (such as the being-operating state, the standby state, or the wake-up state, and so on); or a control instruction of changing any operating parameter, and so on.

More specifically, when the electric toothbrush 100, in the first flight state, does not receive at least one of the instruction of exiting the flight state and the other control instructions within the first predetermined duration, the electric toothbrush 100 still enters the second flight state. For example, when the electric toothbrush 100 does not receive the instruction of exiting the flight state within the predetermined duration, the electric toothbrush 100 enters the second flight state. Alternatively, when the electric toothbrush 100 does not receive the instruction of exiting the flight state and the control instruction of changing any operating parameter within the predetermined duration, the electric toothbrush 100 enters the second flight state.

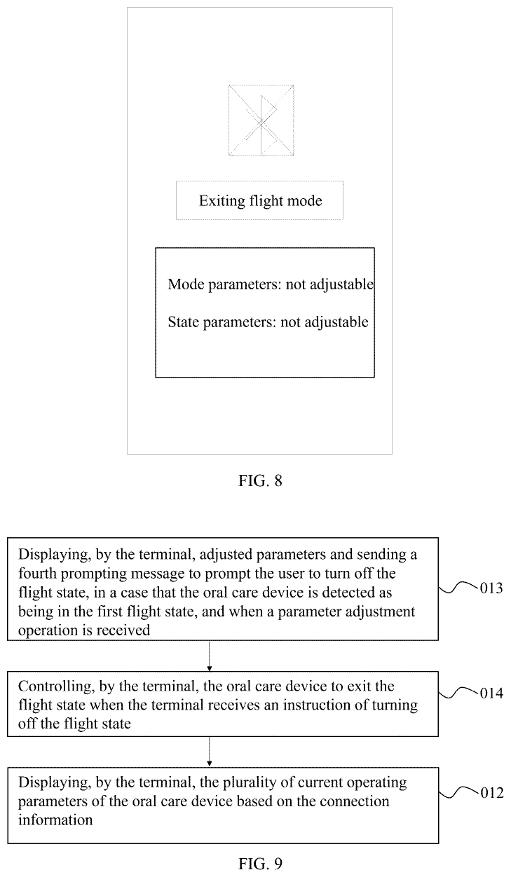

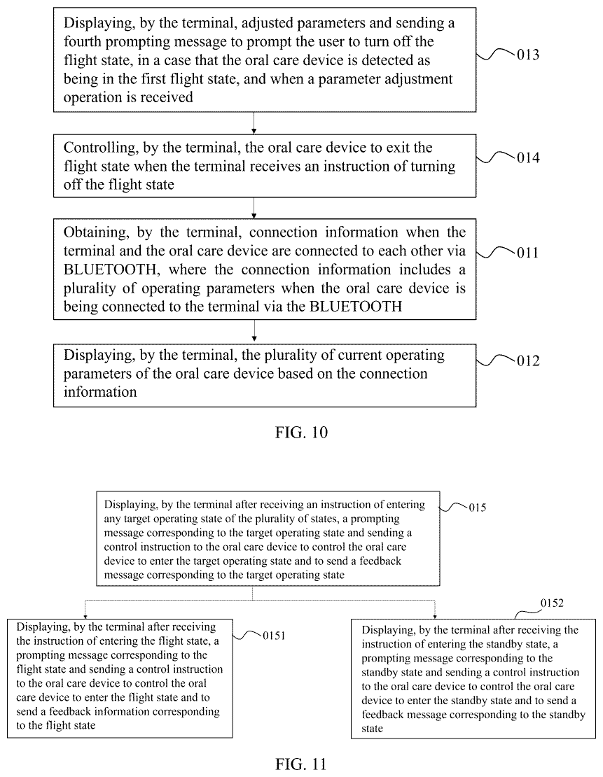

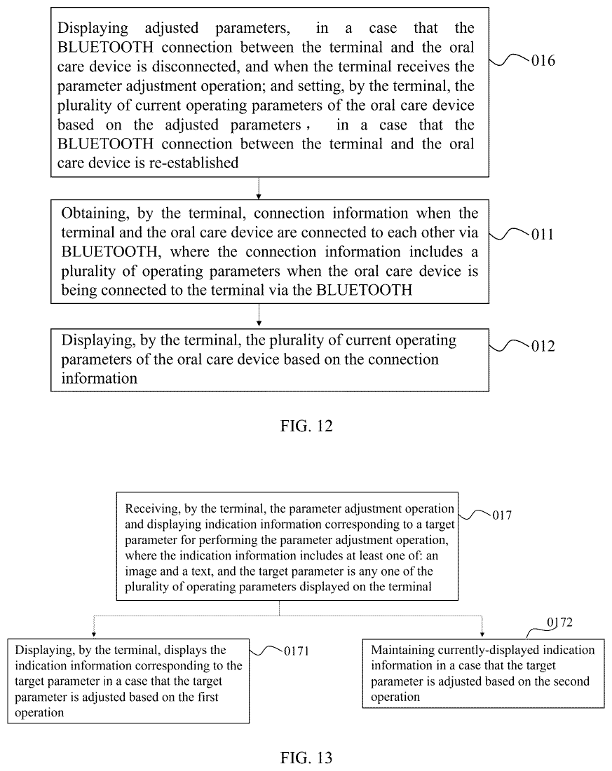

As shown in FIG. 9, in some embodiments, the interactive control method further includes following steps.

In a step 013, in a case that the detection member 10 detects that the oral care device 100 is in the first flight state, when a parameter adjustment operation is received, the terminal 200 displays adjusted parameters and sends a fourth prompting message. The fourth prompting message is configured to prompt the user to turn off the flight state.

In a step 014, when the terminal 200 receives an instruction of turning off the flight state, the terminal 200 controls the oral care device 100 to exit the flight state, and the step 012, in which the plurality of current operating parameters of the oral care device 100 are displayed based on the connection information, is performed again.

Specifically, when the electric toothbrush 100 is in the first flight state, the terminal 200 still obtains the plurality of current operating parameters of the electric toothbrush 100. In a case that it is determined that the electric toothbrush 100 is in the first flight state, when the terminal 200 receives the parameter adjustment operation, i.e., an operation instruction of adjusting at least one of: the mode parameters, the adjustable parameters corresponding to each mode, the state parameters, and the brushing zone change prompting parameters in the plurality of operating parameters, the terminal 200 displays the adjusted operating parameters on the display 2011 and sends the fourth prompting message by texts, voices, or images to prompt the user to turn off the flight state before performing the parameter adjustment operation. When the terminal 200 obtains an instruction indicating turning off the flight state, the terminal 200 controls the electric toothbrush 100 to exit the first flight state and displays the connection information of the electric toothbrush 100 based on the connection information including the plurality of current operating parameters of the electric toothbrush 100 obtained during the BLUETOOTH connection.

It is to be noted that, as shown in FIG. 10, the terminal 200 displays the plurality of current operating parameters of the electric toothbrush 100 when the terminal 200 and the oral care device 100 are connected to each other via the BLUETOOTH. Regardless of at what time the plurality of operating parameters are set and adjusted, the terminal 200 re-obtains the connection information including the plurality of current operating parameters of the electric toothbrush 100 when the electric toothbrush 100 exits the flight state and the BLUETOOTH connection is re-established. Therefore, the step 014, in which the terminal 200 controls the oral care device 100 to exit the flight state and the step 012 of displaying the plurality of current operating parameters of the oral care device 100 based on the connection information is performed again when the terminal 200 receives the instruction of turning off the flight state, may alternatively be the step 014, in which the terminal 200, when receiving the instruction of turning off the flight state, controls the oral care device 100 to exit the flight state, and the step 011 of the terminal 200, when being connected with the oral care device 100 via the BLUETOOTH, obtaining the connection information is performed again.

(2) The terminal 200, when receiving an instruction of entering the standby state, controls the oral care device 100 to enter the first standby state, and after the first standby state lasts for a second predetermined duration, controls the oral care device 100 to enter the second standby state.

Specifically, the terminal 200 controls the oral care device 100 to enter the first standby state when the terminal 200 receives the instruction of entering the standby state, such as any one of: the instruction of entering the flight state sent by touch control, texts or voice inputs via the display 2011 of the terminal 200; the instruction of entering the standby state that is sent by the electric toothbrush 100; or the instruction of entering the standby state sent by the detection member 10 of the electric toothbrush 100 when the detection member 10 detects that the electric toothbrush 100 satisfies the predetermined condition for switching to the standby state. When the oral care device 100 is in the first standby state, the BLUETOOTH device of the electric toothbrush 100 is not switched off, and the one or more prompting members 101 are switched off. That is, at this moment, the terminal 200 and the electric toothbrush 100 are connected to each other via the BLUETOOTH, and the terminal 200 still synchronize the plurality of current operating parameters with the electric toothbrush 200.

After the oral care device 100 stays in the first standby state for the second predetermined duration, such as for the second predetermined duration of 30 s, 1 min, 2 min, 3 min, 5 min, and so on, the terminal 200 controls the electric toothbrush 100 to enter the second standby state. When the oral care device 100 is in the second standby state, the BLUETOOTH device of the electric toothbrush 100 is turned off, and the one or more prompting members 101 are turned off. That is, at this moment, the terminal 200 cannot be connected to the electric toothbrush 100 via the BLUETOOTH.

It is understood that the terminal 200 controls the electric toothbrush 100 to firstly enter the first flight state in which BLUETOOTH is not switched off; after the first predetermined duration, controls the electric toothbrush 100 to enter the second flight state in which BLUETOOTH is switched off. Alternatively, the terminal 200 controls the electric toothbrush 100 to firstly enter the first standby state in which BLUETOOTH is not switched off; after the second predetermined duration, controls the electric toothbrush 100 to enter the second standby state in which BLUETOOTH is switched off. In this way, the electric toothbrush 100 is prevented from mistakenly entering the flight state or the standby state. Even if the electric toothbrush 100 is controlled to mistakenly enter the flight state or the standby state, since the electric toothbrush 100 firstly enters the first flight state or the first standby state in which the BLUETOOTH is not switched off, the terminal 200 still maintains the BLUETOOTH connection with the electric toothbrush 100 and can still control the electric toothbrush 100 to exit the flight state or the standby state that the electric toothbrush 100 mistakenly enters.

As shown in FIG. 11, in some embodiments, the operating state of the oral care device 100 includes a plurality of states, and the method further includes following steps.

In a step 015, the terminal 200, after receiving an instruction of entering any target operating state of the plurality of states, displays a prompting message corresponding to the target operating state and sends a control instruction to the oral care device 100 to control the oral care device 100 to enter the target operating state and to send a feedback message corresponding to the target operating state.

In some embodiments, the operating state of the oral care device 100 includes the flight state and the standby state, and the step 015, in which the terminal 200, after receiving the instruction of entering any target operating state of the plurality of states, displays the prompting message corresponding to the target operating state and sends the control instruction to the oral care device 100 to control the oral care device 100 to enter the target operating state and to send the feedback message corresponding to the target operating state, further includes following steps.

In a step 0151, the terminal 200, after receiving the instruction of entering the flight state, displays a prompting message corresponding to the flight state and sends a control instruction to the oral care device 100 to control the oral care device 100 to enter the flight state and to send a feedback information corresponding to the flight state.

In a step 0152, the terminal 200, after receiving the instruction of entering the standby state, displays a prompting message corresponding to the standby state and sends a control instruction to the oral care device 100 to control the oral care device 100 to enter the standby state and to send a feedback message corresponding to the standby state.

The prompting message may be at least one of a voice message, a text message, or an image message, based on the terminal 200, to indicate which operating state the electric toothbrush 100 enters at this time point to prompt the user to determine the operating state of the electric toothbrush 100. For example, the terminal 200 announces a voice message of the current operating state to the user or displays a text message or an image message corresponding to the current operating state to the user on the display 2011. The feedback message may be at least one of a voice message, a text message, or an image message, based on the one or more prompting members 101 of the electric toothbrush 100, to provide feedback to the user about the current operating state of the electric toothbrush 100. For example, the plurality of states of the electric toothbrush 100 are set to correspond to the plurality of indicator lights 1012. When the electric toothbrush 100 is in the target operating state, one of the plurality of indicator lights 1012 corresponding to the target operating state is illuminating. Alternatively, texts or images corresponding to the target operating state are displayed on the display 1011 of the electric toothbrush 100. Alternatively, voices corresponding to the target operating state are announced by the loudspeaker of the electric toothbrush 100.

Specifically, the operating state of the electric toothbrush 100 includes the flight state and the standby state, and operating parameters corresponding to the flight state are different from operating parameters corresponding to the standby state. The target operating state is one of the flight state and the standby state. When receiving the instruction of entering either target operating state (i.e., the flight state or the standby state), the terminal 200 displays a prompting message corresponding to the target operating state (i.e., the flight state or the standby state) and sends a control instruction to the electric toothbrush 100 to control the electric toothbrush 100 to enter the target operating state (i.e., the flight state or the standby state) and to send a feedback message corresponding to the target operating state (i.e., the flight state or the standby state) to provide feedback to the user about the current operating state of the electric toothbrush 100.

For example, when the instruction of entering the flight state is received, an image corresponding to the flight state is displayed on the display 2011 of the terminal 200, and the terminal 200 sends the control instruction to the electric toothbrush 100 to control the electric toothbrush 100 to enter the flight state and to announce a voice feedback message of “entering the flight state” corresponding to the flight state to provide feedback to the user that the electric toothbrush 100 is currently entering the flight state.

In some embodiments, the instruction of entering the target operating state is generated by at least one of a manual method and an automatic method.

In the manual method, the terminal 200 or the oral care device 100 receives an input operation performed by the user to generate the instruction of entering the target operating state. In the automatic method, when the current state information of the oral care device 100 satisfies a predetermined trigger condition, the instruction of entering the target operating state is generated.

Specifically, the instruction of entering the target operating state is generated by at least one of the manual method and the automatic method. For example, the instruction of entering the target operating state is generated by the manual method; alternatively, the instruction of entering the target operating state is generated by the automatic method; alternatively, the instruction of entering the target operating state is generated by both the manual method and the automatic method.

In a step 016, in a case that the BLUETOOTH connection between the terminal 200 and the oral care device 100 is disconnected, when the terminal 200 receives the parameter adjustment operation, the adjusted parameters are displayed; and in a case that the BLUETOOTH connection between the terminal 200 and the oral care device 100 is re-established, the terminal 200 sets the plurality of current operating parameters of the oral care device 100 based on the adjusted parameters.

The parameter adjustment operation includes an operation of adjusting at least one of: the mode parameters, the adjustable parameters corresponding to each mode, the state parameters, and the brushing zone change prompting parameters in the plurality of operating parameters.

Specifically, in order to enable the user to set the plurality of operating parameters of the electric toothbrush 100 regardless of whether or not the BLUETOOTH connection is disconnected, when the BLUETOOTH connection between the terminal 200 and the electric toothbrush 100 is disconnected, and when the terminal 200 receives at this moment the parameter adjustment operation for adjusting the plurality of operating parameters of the electric toothbrush 100, the display 2011 of the terminal 200 correspondingly displays the adjusted parameters and sets, after the BLUETOOTH connection between the terminal 200 and the electric toothbrush 100 is re-established, the plurality of current operating parameters for the electric toothbrush 100 based on the adjusted parameters. After setting is completed, the terminal 200 obtains the connection information. In this way, regardless of the user setting the plurality of operating parameters when the BLUETOOTH connecting being disconnected or not, the plurality of operating parameters displayed by the terminal 200 can always be synchronized with the plurality of current operating parameters of the electric toothbrush 100.

In some embodiments, the interactive control method further includes following steps.

(1) In a case that the terminal 200 and the oral care device 100 are connected to each other via the BLUETOOTH, when the terminal 200 receives the parameter adjustment operation, the terminal 200 displays the adjusted parameters and sets the plurality of current operating parameters of the oral care device 100 based on the adjusted parameters.

(2) In a case that the BLUETOOTH connection between the terminal 200 and the oral care device 100 is disconnected, when the terminal 200 receives the parameter adjustment operation, the terminal 200 displays the adjusted parameter; and when the BLUETOOTH connection between the terminal 200 and the oral care device 100 is re-established, the terminal 200 displays, based on the connection information, the plurality of current operating parameters of the oral care device 100.

Therefore, regardless of whether the BLUETOOTH connection between the terminal 200 and the electric toothbrush 100 is disconnected or not, when the terminal 200 receives the parameter adjustment operation, the terminal 200 always displays the adjusted operating parameters. When the terminal 200 and the oral care device 100 are connected to each other via the BLUETOOTH, the terminal 200 sets, based on the adjusted operating parameters, the plurality of current operating parameters for the electric toothbrush 100 to synchronize the parameter displayed by the terminal 200 with the plurality of current operating parameters of the electric toothbrush 100.

As shown in FIG. 13, in some embodiments, the interactive control method further includes following steps.

In a step 017, the terminal 200 receives the parameter adjustment operation and displays indication information corresponding to target parameters for performing the parameter adjustment operation is performed. The indication information includes at least one of: an image and a text, and the target parameters are any displayed operating parameters.

Specifically, the target parameters are any operating parameters displayed after the parameter adjustment operation is performed. The terminal 200 receives the parameter adjustment operation and displays the indication information corresponding to the target parameters, and each of the target parameters corresponds to respective indication information. The indication v may include at least one of an image and a text, such as including the image; or including the image and the text. When the terminal 200 receives another parameter adjustment operation, the terminal 200 displays another indication information corresponding to the another parameter adjustment operation correspondingly.

In some embodiments, the parameter adjustment operation includes a first operation and a second operation different from the first operation. For example, the first operation may be a drag-and-drop operation, and the second operation may be a click operation. Alternatively, the first operation is the click operation, and the second operation is the drag-and-drop operation. The step 017, in which the terminal 200 displays the indication information corresponding to the target parameters obtained from the parameter adjustment operation, includes following steps.

In a step 0171, in a case that the target parameters are adjusted based on the first operation, the terminal 200 displays the indication information corresponding to the target parameters.

In a step 0172, in a case that the target parameters are adjusted based on the second operation, the terminal 200 maintains currently-displayed indication information. Specifically, the terminal 200 displays the indication information corresponding to the target parameters when the target parameters are obtained after the first operation of the parameter adjustment operation is performed, and the terminal 200 maintains the currently-displayed indication information unchanged when the target parameters are obtained after the second operation of the parameter adjustment operation is performed.

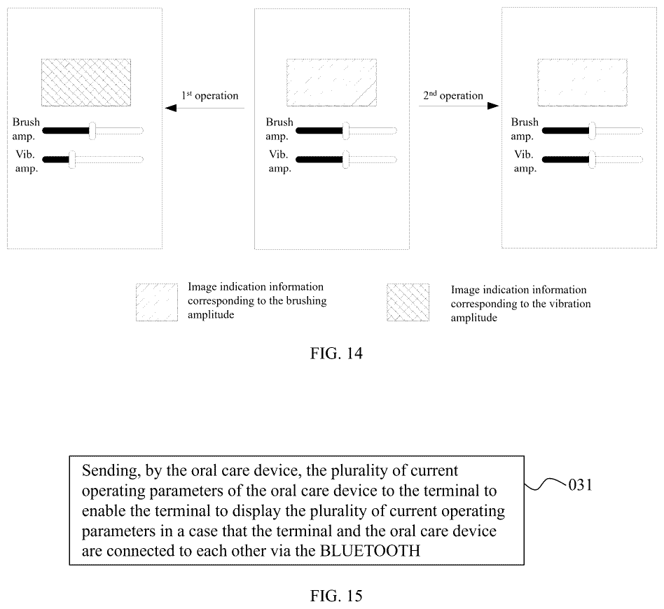

For example, as shown in FIG. 14, when the first operation is the drag-and-drop operation and the second operation is the click operation, the plurality of operating parameters displayed by the terminal 200 include: the mode parameters, the adjustable parameters corresponding to each mode (such as the brushing amplitude, the vibration amplitude, and so on), the state parameters, and the brushing zone change prompting parameters. In an example, the terminal 200 displays the brushing amplitude and the vibration amplitude as the operating parameters. Image indication information corresponding to the brushing amplitude is different from image indication information corresponding to the vibration amplitude. In a case that the indication information corresponding to the brushing amplitude is currently displayed, when the vibration amplitude is adjusted according to the first operation (the drag-and-drop operation), the indication information corresponding to the vibration amplitude is displayed; and when the vibration amplitude is adjusted according to the second operation (the click operation), the indication information corresponding to the brushing amplitude remains being displayed.

It is to be understood that when the parameter adjustment operation is performed on different target parameters, different indication information corresponding to the different target parameters can be displayed. In this way, any changed operating parameter can be intuitively seen. When different parameter adjustment operations are performed on the target parameters, the currently-displayed indication information can be changed or maintained accordingly. In this way, the plurality of operating parameters are prevented from being changed due to a mistaken touch, and therefore, the usage experience is not affected.

In some embodiments, when the oral care device 100 is in the first standby state or the wake-up state, the terminal 200 and the oral care device 100 are connected to each other via the BLUETOOTH; and when the oral care device 100 is in the second standby state, the BLUETOOTH connection between the terminal 200 and the oral care device 100 is disconnected. In the standby state, the one or more prompting members 101 of the oral care device 100 stops operating. In the wake-up state, the one or more prompting members 101 of the oral care device 100 operate. The method further includes: in a case that the oral care device 100 is in the first standby state, the terminal 200, when receiving the parameter adjustment operation, controlling the oral care device 100 to enter the wake-up state.

Specifically, when the electric toothbrush 100 is in the standby state, the one or more prompting members 101 of the oral care device 100 stop operating; and when the electric toothbrush 100 is in the wake-up state, the one or more prompting members 101 operate. When the electric toothbrush 100 is in the first standby state, the BLUETOOTH device of the electric toothbrush 100 is not turned off. When the terminal 200 receives an instruction of the parameter adjustment operation, the terminal 200 controls, via the BLUETOOTH, the electric toothbrush 100 to enter the wake-up state, enabling the one or more prompting members 101 of the electric toothbrush 100 to operate and to prompt the user about what kind of adjustments are made to the plurality of operating parameters.

For example, when the electric toothbrush 100 is in the first standby state and the terminal 200 receives the instruction of the parameter adjustment operation, the terminal 200 controls, via the BLUETOOTH, the electric toothbrush 100 to enter the wake-up state and enables the at least one of the plurality of indicator lights 1012 of the electric toothbrush 100 to start flashing to prompt the user that the electric toothbrush 100 has entered the wake-up state. The user is prevented believing that a power of the electric toothbrush 100 is switched off.

As shown in FIG. 15, the present disclosure further provides an interactive control method, including following steps.

In a step 031, in a case that the terminal 200 and the oral care device 100 are connected to each other via the BLUETOOTH, the oral care device 100 sends the plurality of current operating parameters of the oral care device 100 to the terminal 200 to enable the terminal 200 to display the plurality of current operating parameters.

Specifically, as described above, the electric toothbrush 100 and the terminal 200 are connected to each other via the BLUETOOTH, and in this case, the electric toothbrush 100 sends the plurality of current operating parameters of the electric toothbrush 100 to the terminal 200 to enable the terminal 200 to display the plurality of current operating parameters.

In some embodiments, the operating state of the oral care device 100 is referred to above and will not be repeated herein. The interactive control method further includes following steps.

(1) When the oral care device 100 receives the instruction of entering the flight state, the oral care device 100 enters the first flight state, and after staying in the first flight state for the first predetermined duration, the oral care device 100 enters the second flight state.

Specifically, the processor 30 of the electric toothbrush 100 controls the electric toothbrush 100 to enter the first flight state when the oral care device 100 receives the instruction of entering the flight state, such as any one of: the instruction of entering the flight state sent from the terminal 200; the instruction of entering the flight state sent from the processor 30 of the oral care device 100; or the detection member 10 of the electric toothbrush 100 determining that the electric toothbrush 100 satisfying the predetermined condition for entering the flight state. In the first flight state, the BLUETOOTH device of the electric toothbrush 100 is not turned off, and the one or more prompting members 101 are turned off. That is, at this moment, the electric toothbrush 100 and the terminal 200 are still connected to each other via the BLUETOOTH, and the electric toothbrush 100 still synchronizes the plurality of current operating parameters to the terminal 200.

After the electric toothbrush 100 stays in the first flight state for the first predetermined duration, such as 30 seconds(s), 1 min, 2 min, 3 min, 5 min, and so on, the processor 30 of the electric toothbrush 100 controls the electric toothbrush 100 to enter the second flight state. In the second flight state, the BLUETOOTH device of the electric toothbrush 100 is turned off, and the one or more prompting members 101 are turned off, and that is, at this moment, the electric toothbrush 100 and the terminal 200 cannot be connected to each other via the BLUETOOTH.

(2) In a case that the electric toothbrush 100 receives the instruction of entering the standby state, the electric toothbrush 100 enters the first standby state, and after staying in the first standby state for the second predetermined duration, the electric toothbrush 100 enters the second standby state.

Specifically, the processor 30 of the electric toothbrush 100 controls the electric toothbrush 100 to enter the standby state when the electric toothbrush 100 receives the instruction of entering the standby state, such as any one of: the instruction of entering the standby state sent from the terminal 200; the instruction of entering the standby state sent from the processor 30 of the oral care device 100; or the detection member 10 of the electric toothbrush 100 determining that the electric toothbrush 100 satisfying the predetermined condition for entering the standby state. In the first standby state, the BLUETOOTH device of the electric toothbrush 100 is not turned off, and the one or more prompting members 101 are turned off. That is, at this moment, the electric toothbrush 100 and the terminal 200 are still connected to each other via the BLUETOOTH, and the electric toothbrush 100 still synchronizes the plurality of current operating parameters to the terminal 200.

After the electric toothbrush 100 stays in the first standby state for the first predetermined duration, such as 30 seconds(s), 1 min, 2 min, 3 min, 5 min, and so on, the processor 30 of the electric toothbrush 100 controls the electric toothbrush 100 to enter the second standby state. In the second standby state, the BLUETOOTH device of the electric toothbrush 200 is turned off, and the one or more prompting members 101 are turned off, i.e., at this moment, the electric toothbrush 100 and the terminal 200 cannot be connected to each other via the BLUETOOTH.

In some embodiments, the interactive control method further includes: in the case that the electric toothbrush 100 receives the instruction of entering any one of a plurality of operating states, the electric toothbrush 100 enters the target operating state and sends the feedback message corresponding to the target operating state.

The plurality of operating states of the electric toothbrush 100 and the feedback information can be referred to above and will not be repeated herein.

For example, the plurality of operating states of the oral care device 100 include the standby state or the wake-up state, and the electric toothbrush 100 enters the wake-up state after receiving the target operating state of entering the wake-up state. The processor 30 of the electric toothbrush 100 controls the electric toothbrush 100 to send the feedback message of the display 1011 being lit up to provide feedback to the user that the electric toothbrush 100 is currently in the wake-up state.

In some embodiments, the interactive control method further includes: the oral care device 100 entering the standby state when the oral care device 100 staying in the wake-up state and receiving no control instruction within a third predetermined duration.

The third predetermined duration may be, such as, 15 s, 20 s, 30 s, 60 s, and so on. The control instruction may be a control instruction of controlling the electric toothbrush 100 to enter any operating state other than the wake-up state (such as the operating state, the standby state, or the flight state, and so on) or changing the adjustable parameters and other control instructions of performing changes to the plurality of current operating parameters of the electric toothbrush. The control instruction may be a control instruction that is transmitted via the APP of the terminal 200 to the electric toothbrush 100 to change the plurality of operating parameters.

Specifically, in order to save energy consumption of the electric toothbrush 100 and improve a standby duration of the electric toothbrush 100, when the electric toothbrush 100 is in the wake-up state, the motor of the electric toothbrush 100 does not run, but the one or more prompting members 101 operate. When the electric toothbrush 100 does not receive the control instruction within the third predetermined duration, the processor 30 of the electric toothbrush 100 controls the electric toothbrush 100 to enter the standby state in which the one or more prompting members 101 are turned off.

It is to be noted that the detection element 10 of the electric toothbrush 100 does not generate the control instruction when the detection element 10 of the electric toothbrush 100, in the wake-up state, detects that no usage is performed within the third predetermined duration. That is, when the detection element 10 of the electric toothbrush 100, in the wake-up state, detects that no usage is performed within the third predetermined duration, the processor 30 of the electric toothbrush 100 controls the electric toothbrush 100 to enter the standby state in which the one or more prompting members 101 are turned off.

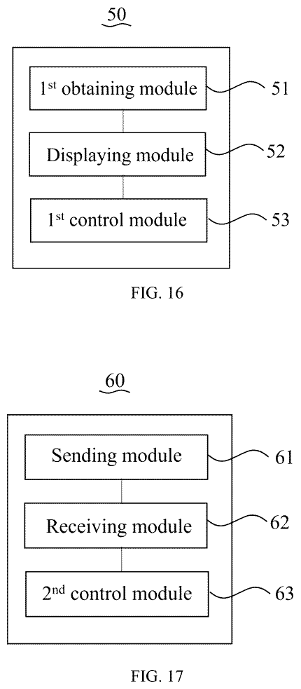

As shown in FIG. 16, in order to facilitate better implementation of the interactive control method of the present embodiments, the present embodiments further provide an interaction control apparatus 50, the interaction control apparatus 50 includes a first obtaining module 51 and a display module 52. The first obtaining module 51 is configured to obtain the connection information when the terminal 200 and the oral care device 100 are connected to each other via the BLUETOOTH. The connection information includes the plurality of operating parameters when the oral care device 100 is connected via the BLUETOOTH. The display module 12 is configured to display the plurality of current operating parameters of the oral care device 100 based on the connection information. Exemplarily, the display module 12 may be understood as the display 1011 of the oral care device 100. In some embodiments, the display module 12 may alternatively be understood as the display 2011 of the terminal 200.

In some embodiments, the display module 52 is further configured to display the plurality of previous operating parameters when the terminal 200 and the oral care device 100 are connected to each other via BLUETOOTH at the previous time as the plurality of current operating parameters.

In some embodiments, the display module 52 is further configured to display a plurality of operating parameters when the terminal 200 and the oral care device 100 are currently connected to each other via the BLUETOOTH as the plurality of current operating parameters.

In some embodiments, the display module 52 is specifically further configured to send the first prompting message and set at least a portion of the plurality of current operating parameters displayed on the terminal to the unadjustable state when the BLUETOOTH connection between the terminal 200 and the oral care device 100 is disconnected. The first prompting message is configured to prompt that the BLUETOOTH connection is disconnected.

In some embodiments, the interaction control apparatus 50 further includes a first control module 53 configured to: control the oral care device 100 to enter the first flight state when receiving the instruction of entering the flight state; control the oral care device 100 to enter the second flight state after the oral care device 100 stays in the first flight state for the first predetermined duration; control the oral care device 100 to enter the first standby state after receiving the instruction of entering the standby state; and control the oral care device 100 to enter the second standby state after the oral care device 100 stays in the first standby state lasts for the second predetermined duration.

In some embodiments, the first control module 53 is specifically further configured to control the oral care device 100 to enter the second flight state when the oral care device 100, in the first flight state, does not receive at least one of the instruction of exiting the flight state and other control instructions within the first predetermined duration.

In some embodiments, the first control module 53 is specifically further configured to, in the case of receiving the instruction of entering any target operating state of the plurality of operating states, control the display module 52 to display the prompting message corresponding to the target operating state; send the control instruction to the oral care device 100 to control the oral care device 100 to enter the target operating state; and send the feedback message corresponding to the target operating state.

In some embodiments, the first control module 53 is further specifically configured to: control the display module 52 to display, in the case of receiving the instruction of entering the flight state, the prompting message corresponding to the flight state; send the control instruction to the oral care device 100 to control the oral care device 100 to enter the flight state and to send the feedback message corresponding to the flight state; control the display module 52 to display, in the case of receiving the instruction of entering the standby state, the prompting message corresponding to the standby state; send the control instruction to the oral care device 100 to control the oral care device 100 to enter the standby state; and send the feedback message corresponding to the standby state.

In some embodiments, the display module 52 is specifically further configured to: display the adjusted parameters when the parameter adjustment operation is received, in the case that the oral care device 100 is detected to be in the first flight state; send the fourth prompting message configured to prompt the user to switch off the flight state; control the oral care device to exit the flight state when the instruction of switching off the flight state is received; and perform the step of displaying the plurality of current operating parameters of the oral care device according to the connection information.

In some embodiments, the display module 52 is specifically further configured to: display the adjusted parameters when the parameter adjustment operation is received in the case that the BLUETOOTH connection between the terminal 200 and the oral care device 100 is disconnected; display the plurality of current operating parameters of the oral care device 100 based on the adjusted parameters in the case that the terminal 200 is connected to the oral care device 100 via the BLUETOOTH again.

In some embodiments, the display module 52 is specifically further configured to display the adjusted parameters when the parameter adjustment operation is received in the case that the terminal 200 and the oral care device 100 are connected to each other via the BLUETOOTH; display the plurality of current operating parameters of the oral care device based on the adjusted parameters when the parameter adjustment operation is received in the case that the BLUETOOTH connection between the terminal 200 and the oral care device 100 is disconnected; display the plurality of current operating parameters of the oral care device based on the connection information when the terminal 200 is connected to the oral care device 100 via the BLUETOOTH again.

In some embodiments, the display module 52 is specifically further configured to: receive the parameter adjustment operation; display indication information corresponding to the target parameters on which the parameter adjustment operation is performed. The indication information includes at least one of an image and a text, and the target parameters are any displayed operating parameters.

In some embodiments, the display module 52 is specifically further configured to: display the indication information corresponding to the target parameters in the case that the target parameters are adjusted based on the first operation; and maintain the currently-displayed indication information unchanged in the case that the target parameters are adjusted based on the second operation.

In some embodiments, the first control module 53 is specifically further configured to control the oral care device 100 to enter the wake-up state when the parameter adjustment operation is received in the first standby state.

In some embodiments, the display module 52 is specifically further configured to: display the initial mode interface, which is determined, based on the plurality of pervious operating parameters when the terminal 200 and the oral care device 100 are connected to each other at the previous time; switch from the initial mode interface to the target mode interface in the case that the plurality of current operating parameters mismatch the plurality of previous operating parameters; and remain displaying the initial mode interface in the case that the plurality of current operating parameters match the plurality of previous operating parameters.

Exemplarily, functions of the first control module 53 and functions of the processor 30 are at least partially overlapped with each other, for example, the first control module 53 is a part or the entirety of the processor 30.

As shown in FIG. 17, in order to facilitate better implementation of the interactive control method of the present disclosure, the present disclosure further provides an interaction control apparatus 60, the interaction control apparatus 60 includes a sending module 61. The sending module 61 is configured to send, in the case that the interaction control apparatus 60 is connected with the terminal 200 via the BLUETOOTH, the plurality of current operating parameters of the oral care device 100 to the terminal 200 to enable the terminal 200 to display the plurality of current operating parameters.

In some embodiments, the interaction control apparatus 60 further includes a receiving module 62, which is configured to: enter the first flight state after receiving the instruction of entering the flight state; enter the second flight state after staying in the first flight state for the first predetermined duration; enter the first standby state after receiving the instruction of entering the standby state; and enter the second standby state after staying in the first standby state for the second predetermined duration.

Exemplarily, the sending module 61 may be understood as a BLUETOOTH signal sending member of the first BLUETOOTH unit 103 or as a program configured to send the BLUETOOTH signal. Exemplarily, the receiving module may be understood to as a BLUETOOTH signal receiving member of the first BLUETOOTH unit 103 or understood a program configured to receive the BLUETOOTH signal.

In some embodiments, the receiving module 62 is specifically further configured to enter the target operating state and send the feedback message corresponding to the target operating state, in the case of receiving the instruction of entering any target operating state of the plurality of operating states.

In some embodiments, the interaction control device 60 further includes a second control module 63, the second control module 63 is configured to enter the standby state in the case that the oral care device 100 is in the wake-up state and does not receive the control instruction within the third predetermined duration.

In some embodiments, the second control module 63 is specifically further configured to control the one or more prompting members 101 to operate in the wake-up state; and control the one or more prompting members 101 to stop operating in the flight state or the standby state.

Exemplarily, functions of the second control module 63 and functions of the processor 30 are at least partially overlapped with each other, for example, the second control module 63 may be a part or the entirety of the processor 30.

The steps of the method in all embodiments of the present disclosure may be performed by integrated logic circuits of hardware in the processor and/or instructions in the form of software. The steps of the method disclosed in the embodiments of the present disclosure may be directly embodied as being performed by a hardware encoded processor, or performed with a combination of hardware and software modules in the encoded processor. In some embodiments, the software modules may be located in a random memory, a flash memory, a read-only memory, a programmable read-only memory, an electrically erasable programmable memory, a register, or any storage medium that is well established in the art. The storage medium is located in the memory, the processor and the memory are electrically connected to each other, and the processor reads information in the memory and completes the steps in the method described above in combination with the hardware. It is noted that the terminal 200 or the oral care device 100 may enroll the memory and the processor.

As shown in FIG. 1, the oral care device 100 of the present embodiment includes the processor 30, the memory 40, and a computer program. The computer program is stored in the memory 40, the memory 40 is electrically coupled to the processor 30, and the computer program is executed by the processor 30, the computer program includes instructions for executing the interactive control method of some of the above-described embodiments.

The terminal 200 of the present embodiment includes the processor, the memory, and a computer program. The computer program is stored in the memory of the terminal 200, the memory of the terminal 200 is electrically connected to the processor, and the computer program is executed by the processor of the terminal 200. The computer program includes instructions for executing the interactive control method of some of the above embodiments.

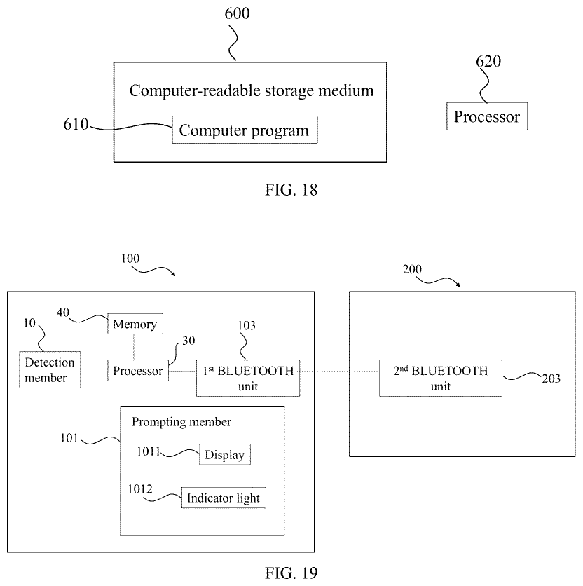

As shown in FIG. 18, embodiments of the present application further provide a computer-readable storage medium 600, and a computer program 610 is stored on the computer-readable storage medium 600. When the computer program 610 is executed by a processor 620, steps of the interactive control method in any of the above embodiments are performed. For brevity, the processor 620 may be the processor 30 of the oral care device 100 or the processor of the terminal 200.

In the specification herein, reference to the terms “some embodiments”, “an example”, “exemplarily”, and so on, mean that specific features, structures, materials, or characteristics described in one embodiment or example are included in at least one of the embodiments or examples of the present disclosure.

Any process or method described in the flow chart or otherwise described herein may be interpreted as including a module, a fragment, or a portion of codes including one or more executable instructions for implementing the steps of a particular logical function or process. The scope of preferred embodiments of the present disclosure includes additional implementations, in which any order other than the order shown or discussed herein may be applied, for example, involved functions may be performed in an essentially simultaneous manner or in a reverse order.

What is claimed is:

1. An interactive control method, comprising:
obtaining, by a terminal, connection information in a case that an oral care device and the terminal are connected to each other via BLUETOOTH; wherein the connection information comprises a plurality of operating parameters of the oral care device when the oral care device is connected to the terminal via the BLUETOOTH; and
displaying, by the terminal, a plurality of current operating parameters of the oral care device based on the connection information.

2. The interactive control method according to claim 1, wherein the connection information comprises historical connection information; the historical connection information comprises a plurality of previous operating parameters, the plurality of previous operating parameters are a plurality of operating parameters of the oral care device when the oral care device and the terminal are connected to each other via BLUETOOTH at a previous time; and displaying the plurality of current operating parameters of the oral care device based on the connection information comprises:
displaying, by the terminal, the plurality of previous operating parameters as the plurality of current operating parameters.

3. The interactive control method according to claim 1, wherein the connection information comprises current connection information; the current connection information comprises a plurality of operating parameters of the oral care device when the oral care device and the terminal are currently connected to each other via BLUETOOTH; and displaying the plurality of current operating parameters of the oral care device based on the connection information comprises:
displaying, by the terminal, the plurality of operating parameters of the oral care device when the oral care device and the terminal are currently connected to each other via BLUETOOTH, as the plurality of current operating parameters.

4. The interactive control method according to claim 1, wherein the interactive control method further comprises:
sending, by the terminal in a case that BLUETOOTH connection between the terminal and the oral care device is disconnected, a first prompting message and setting at least part of the plurality of current operating parameters displayed on the terminal to an unadjustable state, wherein the first prompting message is configured to prompt that the BLUETOOTH connection is disconnected.

5. The interactive control method according to claim 1, wherein the oral care device comprises a plurality of operating states, the plurality of operating states comprise a flight state, a standby state, a wake-up state, and a being-operating state; the flight state comprises a first flight state and a second flight state; the standby state comprises a first standby state and a second standby state;
when the oral care device is in the first flight state, the first standby state, the wake-up state or the being-operating state, the terminal and the oral care device are connected to each other via the BLUETOOTH; when the oral care device is in the second flight state or the second standby state, the BLUETOOTH connection between the terminal and the oral care device is disconnected; and the interactive control method further comprises:
controlling, by the terminal in a case that the terminal receives an instruction of entering the flight state, the oral care device to enter the first flight state; after the oral care device stays in the first flight state for a first predetermined duration, controlling, by the terminal, the oral care device to enter the second flight state; and
controlling, by the terminal in a case that the terminal receives an instruction of entering the standby state, the oral care device to enter the first standby state; after the oral care device stays in the first standby state for a second predetermined duration, controlling, by the terminal, the oral care device to enter the second standby state.

6. The interactive control method according to claim 5, wherein the step of, after the oral care device staying in the first flight state for a first predetermined duration, the terminal controlling the oral care device to enter the second flight state comprises:
controlling, by the terminal in the case that the oral care device is in the first flight state and the terminal does not receive at least one of an instruction of exiting the flight state and other control instructions within the first predetermined duration, the oral care device to enter the second flight state.

7. The interactive control method according to claim 1, wherein the oral care device comprises a plurality of operating states, and the interactive control method further comprises:
displaying, by the terminal after receiving an instruction of entering a target operating state, a prompting message corresponding to the target operating state, sending, by the terminal, a control instruction to the oral care device to control the oral care device to enter the target operating state and to send a feedback message corresponding to the target operating state; wherein the target operating state is any one of the plurality of operating states.

8. The interactive control method according to claim 7, wherein the plurality of operating states of the oral care device comprise a flight state and a standby state, and the interactive control method further comprises:
displaying, by the terminal in a case of receiving an instruction of entering the flight state, a prompting message corresponding to the flight state; sending a first control instruction to the oral care device to control the oral care device to enter the flight state and to send a feedback message corresponding to the flight state; and
displaying, by the terminal in a case of receiving an instruction of entering the standby state, a prompting message corresponding to the standby state; sending a second control instruction to the oral care device to control the oral care device to enter the standby state and to send a feedback message corresponding to the standby state.

9. The interactive control method according to claim 5, wherein the plurality of operating states of the oral care device comprise the flight state, the flight state comprises the first flight state and the second flight state; in a case that the oral care device is in the first flight state, the terminal is connected to the oral care device via the BLUETOOTH; and in a case that the oral care device is in the second flight state, BLUETOOTH connection between the terminal and the oral care device is disconnected; and the interactive control method further comprises:
displaying, by the terminal in a case of detecting that the oral care device is in the first flight state and after receiving a parameter adjustment operation, adjusted parameters and sending a fourth prompting message to prompt a user to turn off the flight state;
controlling, by the terminal in a case of receiving an instruction of turning off the flight state, the oral care device to exit the flight state and performing the step of displaying the plurality of current operating parameters of the oral care device based on the connection information again.

10. The interactive control method according to claim 1, wherein before obtaining the connection information by the terminal, the interactive control method further comprises:
displaying, by the terminal in a case of BLUETOOTH connection between the terminal and the oral care device being disconnected and after receiving a parameter adjustment operation, adjusted parameters; and setting, in a case of the terminal and the oral care device being connected via the BLUETOOTH again, the plurality of current operating parameters of the oral care device based on the adjusted parameters.

11. The interactive control method according to claim 1, wherein the interactive control method further comprises:
displaying, by the terminal in a case of the terminal and the oral care device being connected via the BLUETOOTH and after receiving a parameter adjustment operation, adjusted parameters; and setting the plurality of current operating parameters of the oral care device based on the adjusted parameters; and
displaying, by the terminal in a case of BLUETOOTH connection between the terminal and the oral care device being disconnected and after receiving the parameter adjustment operation, the adjusted parameters; and displaying, in a case of the terminal and the oral care device being connected via the BLUETOOTH again, the plurality of current operating parameters of the oral care device based on the connection information.

12. The interactive control method according to claim 1, wherein the interactive control method further comprises:
receiving, by the terminal, a parameter adjustment operation; displaying, based on a target parameter for performing the parameter adjustment operation, indication information corresponding to the target parameter; wherein the indication information comprises at least one of an image and a text, and the target parameter is any one of the plurality of current operating parameters displayed on the terminal.

13. The interactive control method according to claim 12, wherein the parameter adjustment operation comprises a first operation and a second operation different from the first operation; the step of displaying, based on the target parameter for performing the parameter adjustment operation, the indication information corresponding to the target parameter comprises:
displaying, by the terminal in a case that the target parameter is adjusted based on the first operation, the indication information corresponding to the target parameter; and
remaining, by the terminal in a case that the target parameter is adjusted based on the second operation, the indication information that is currently displayed unchanged.

14. The interactive control method according to claim 1, wherein the oral care device has a plurality of operating states; the plurality of operating states comprise a standby state and a wake-up state; the standby state comprises a first standby state and a second standby state; in a case that the oral care device is in the first standby state or the wake-up state, the terminal and the oral care device are connected to each other via the BLUETOOTH; in a case that the oral care device is in the second standby state, BLUETOOTH connection between the terminal and the oral care device is disconnected; a prompting member of the oral care device stops operating in the standby state; the prompting member of the oral care device operates in the wake-up state; and the interactive control method further comprises:
controlling, by the terminal when receiving a parameter adjustment operation in the case that the oral care device is in the first standby state, the oral care device to enter the wake-up state.

15. The interactive control method according to claim 1, wherein before the step of displaying, by the terminal, the plurality of current operating parameters of the oral care device based on the connection information, the interactive control method further comprises:
displaying, by the terminal, an initial mode interface, wherein the initial mode interface is determined based on the plurality of previous operating parameters;
switching, by the terminal in a case that the plurality of current operating parameters mismatch the plurality of previous operating parameters, from the initial mode interface to a target mode interface, wherein the target mode interface is determined based on the plurality of current operating parameters; and
remaining displaying, by the terminal in a case that the plurality of current operating parameters match the plurality of previous operating parameters, the initial mode interface.

16. An interactive control method, comprising:
sending, by an oral care device in a case that the oral care device and a terminal are connected to each other via BLUETOOTH, a plurality of current operating parameters of the oral care device to the terminal to enable the terminal to display the plurality of current operating parameters.

17. The interactive control method according to claim 16, wherein operating states of the oral care device comprise a flight state, a standby state, a wake-up state and a being-operating state; the flight state comprises a first flight state and a second flight state; the standby state comprises a first standby state and a second standby state; when the oral care device is in the first flight state, the first standby state, the wake-up state or the being-operating state, the terminal and the oral care device are connected to each other via the BLUETOOTH; when the oral care device is in the second flight state or the second standby state, the BLUETOOTH connection between the terminal and the oral care device is disconnected; and the interactive control method further comprises:
the oral care device entering, in a case of receiving an instruction of entering the flight state, the first flight state; after staying in the first flight state for a first predetermined duration, entering the second flight state; and
when the oral care device receives an instruction of entering the standby state, entering the first standby state; and entering the second standby state after staying in the first standby state for a second predetermined duration.

18. The interactive control method according to claim 16, wherein the oral care device comprises a plurality of operating states, and the interactive control method further comprises:
entering, a target operating state and sending a feedback message corresponding to the target operating state when the oral care device receives an instruction of entering the target operating state, wherein the target operating state is any one of the plurality of operating states.

19. The interactive control method according to claim 16, wherein operating states of the oral care device comprise a wake-up state and a standby state; and the interactive control method further comprises:
entering the standby state when the oral care device is in the wake-up state and does not receive any control instruction within a third predetermined duration.

20. The interactive control method according to claim 16, wherein operating states of the oral care device comprise a flight state, a standby state, a wake-up state and a being-operating state;
the oral care device comprises a prompting member; and the interactive control method further comprises:
when the oral care device is in the wake-up state or the being-operating state, controlling the prompting member to operate; and
when the oral care device is in the flight state or the standby state, controlling the prompting member to stop operating.
